(19) United States
(12) Patent Application Publication
(10) Pub. No.: US 2015/0052212 A1
(43) Pub. Date: Feb. 19, 2015

(54) System and Method for Processing Electronic Mail

(71) Applicant: IQTell.com, LLC, Old Bridge, NJ (US)

(72) Inventor: Ran J. Flam, Marlboro, NJ (US)

(73) Assignee: IQTELL.COM, LLC, Old Bridge, NJ (US)

(21) Appl. No.: 14/462,862

(22) Filed: Aug. 19, 2014

Related U.S. Application Data
(60) Provisional application No. 61/959,258, filed on Aug. 19, 2013.

(51) Int. Cl. H04L 12/58

(52) U.S. Cl. CPC H04L 51/02
USPC 709/206

(57) ABSTRACT

A system and method for processing electronic mail is disclosed herein. The system for processing electronic mail, comprising a computer system in electronic communication with a network, the computer system receiving and sending one or more email messages over the network, and an email client application executed by the computer system, the email client application generating on said computer system, an electronic user interface for allowing a user to process the one or more email messages, a first toolbar for allowing the user to control operation of the email client application, and a secondary toolbar including at least one macro button selectable by the user when the one or more email messages are displayed to the user in the electronic user interface, the at least one macro button having assigned thereto a user-definable macro which, when selected by the user, automatically processes the one or more email messages.

### CROSS-REFERENCE TO RELATED APPLICATIONS

This application claims the benefit of U.S. Provisional Application Ser. No. 61/959,258 filed on Aug. 19, 2013 and pending U.S. Non-Provisional application Ser. No. 13/186,085, filed on Jul. 19, 2011 (published as U.S. Patent Application Publication No. 2012/0096389), which claims priority from U.S. Provisional Application No. 61/394,487, filed Oct. 19, 2010, the entire disclosures of which are expressly incorporated herein by reference.

### BACKGROUND

1. Field of the Disclosure

The present disclosure relates to a method for expediting email processing, creating actions, and creating and linking to data structures.

2. Background

Existing email client software allows users to process email by picking certain “commands” from a pre-defined menu, and/or using certain keys, such as keyboard shortcuts (e.g., ‘e’ for “Archive”). Microsoft Outlook, an email client software solution, allows users to define “Quick Steps,” where each “Quick Step” is a combination of operations, such as changing the status of email (e.g., “Mark as Read,” categorize or flag an email, move an email to a predefined destination, etc.). Further, each “Quick Step” can be assigned a meaningful name. Any of the predefined “Quick Steps” can be applied to a given one or more email messages to process email using Microsoft Outlook.

Pre-defined keyboard shortcuts, menu items, and the application of pre-defined “steps” are all applied to, and contained within, the given client email corresponding folders and sub-folders structure. However, processing email by flagging and/or moving email messages from one folder to another within a folder structure (e.g., moving email from the “Inbox” to the “Work” or “Household” folders), merely provides a “filing system” with just better ways for filing and categorizing.

### SUMMARY

Disclosed herein is a system and method for processing electronic mail. The disclosure provides a system and method for improving the processing of email by applying user-defined macros to one or more selected email messages.

The disclosure provides the ability to define macros for subsequent application to an object (e.g., for execution on email received or sent by the user). More specifically, the macros provide the ability to convert email into action and/or any other structured information as well as execute any additional predetermined steps (e.g., archive, delete, and/or move the email to another email folder). Many different macros and types of macros could be used. For example, a macro could create an action or a task associated with an email and then archive that email. Another macro could be defined and executed to attach email messages to existing actions or projects and then move the email to a predetermined folder. Another macro could be defined and executed to create a new entry under any folder such as the “Purchases” folder based on a received email (e.g., an order confirmation from Amazon.com). Another macro could be defined and executed to create a new entry in the “Tips and Know How” folder from email that has useful information that the user wants to convert and keep its content as an entry in such a non-email folder. Other examples of user-defined macros would be macros to link selected one or more email messages to any existing entry, such as an action or a project, under the “Actions” or “Projects” folders, respectively, where said folders are non-email folders.

### BRIEF DESCRIPTION OF THE DRAWINGS

The foregoing features of the disclosure will be apparent from the following Detailed Description, taken in connection with the accompanying drawings, in which:

FIG. 1 is a screenshot of a secondary toolbar while in Tabular View;

FIG. 2 is a screenshot of the secondary toolbar while in Full View;

FIG. 3 is a screenshot of the secondary toolbar including keyboard shortcut prefixes;

FIG. 4 is a screenshot of a configuration menu of a user-defined macro;

FIG. 5 is a screenshot of a Macro Manager of the secondary toolbar;

FIG. 6 is a screenshot of a zoomed in view of the Macro Manager showing a sub-menu of a macro;

FIG. 7 is a screenshot of a configuration menu while in Create View;

FIG. 8 is a screenshot of a Macro Editor while in Create View;

FIG. 9 is a screenshot of a Macro Editor while in Full View;

FIG. 10 is a screenshot of a Macro Editor while in List View;

FIG. 11 is a screenshot of a destination entry selection;

FIG. 12 is a system diagram; and

FIGS. 13-14 are flowcharts showing processing steps carried out by the system.

### DETAILED DESCRIPTION

Disclosed herein is a system and method for processing electronic mail. More specifically, disclosed herein is a system and method that allows users to define “macros” (e.g., customizable user-defined macros) that can be executed on new and/or existing email, as well as when composing, replying or forwarding email messages. The system comprises email and non-email folders. Examples of email folders are “Inbox” and “Sent Items.” Examples of non-email folders are “Actions,” “Projects,” “Purchases,” and “Travel Itineraries.” Entries in an email folder are described as email messages and entries in non-email folders are described as “data entries” or “structured data entries,” meaning records of data where each record has a set of configured data fields. For example, a reference to “action” means an entry in a folder named “Actions” or a sub-folder thereof, and a “project” is an entry in a folder named “Projects” or a sub-folder thereof. Using this system, the user can use “out of the box” preconfigured folders and sub-folders of non-email data and can also add folders and sub-folders on their own.

Each macro contains one or more elements that creates one or more structured data entries in non-email folders, such as, without limitation, actions that must be fulfilled (by the user), projects, purchases and travel plans, etc., all with respect to one or more selected email messages. By way of configuration, creation of the entries also automatically copies content elements from the email to the newly created entries. For example, for a macro executed on an email, copying the subject of the email to the “Short Description” field of the newly created data entry and, similarly, copying the HTML body of the email to the “Notes” data field of the newly created entry.

Macros can be defined to convert email into action and/or meaningful structured information, and can also be defined to link email to existing entries in non-email structured folders. Whenever a new data entry is created or linked to, the system maintains the necessary linkage information in its database so that when opening any such given data entry, the user can see the one or more email messages linked to the entry and from there, click such links that will automatically open the corresponding email messages (without having to search for such email in the corresponding email folder). Thus, by way of example, users of the system can open an action or a project and see the email that was used to create the entry as well as all consequent email messages that were sent or received with respect to that entry. Macros can also be configured to set up reminders or to create calendar events based on any given email. Finally, macros can also be defined to execute email-related functionality such as delete, archive or move email to a predetermined folder (once it has been processed according to the given macro). The system provides a user interface which allows users to create new macros, view and modify existing macros (e.g., on an “ad hoc” basis prior to execution), specify/identify elected macros, and organize their displayed order in a “secondary toolbar.” The following figures and disclosure are with respect to an IQTELL (IQ) application, although any other type of application could be used.

The following examples illustrate the usefulness and benefits of the system and method provided herein:

### Example 1

A customer support person receives an email and applies a macro with the following elements: (i) create a new entry in an action-item type folder called “Customer Support”; (ii) automatically copy the subject and the body of the email; (iii) set the “Priority” of the new action to “High”; (iv) set the “Due Date” to be two days from the date of execution of the macro (e.g., the current date); and lastly (v) move the email from the “Inbox” folder to an “Action Taken” email folder.

### Example 2

A technical support person composes a new email responding to an email requesting technical support (as per Example 1) where the outbound email needs to be attached (e.g., linked to a given entry in the “Customer Support” non-email folder that corresponds to the given support issue. In which case, while composing said new email, the user selects a macro having the following elements: (i) prompt the user to search and select the corresponding entry in the “Customer Support” non-email folder; (ii) attach (e.g., link) the newly created email (placed in the “Sent Items” folder) to the entry within the “Customer Support” folder; and (iii) set the status of the non-email entry to “In Progress.” Using this example, the user can open the “Customer Support” folder, see all entries there, the status of each entry (record) as well as view all email associated with any such entry (in this case, see the email sent to the customer).

### Example 3

A user receives an email from an online vitamin store, indicating that a given order has shipped, and wishes to process said email so that (i) it will be attached to the corresponding purchase (entry) in the “Purchases” non-email folder; (ii) change the status of said non-email entry to “Shipped”; and (iii) automatically archive said email. In this case, the user will select a macro having the following configured elements (i) prompt the user to search and select the corresponding entry in the “Purchases” non-email folder (ii) attach (i.e., link) said email to the selected non-email entry; (iii) set the status of said purchase to “Shipped”; and (iv) archive said email.

The current disclosure uses the following acronyms and terminology:

CV: Create View—the view used when creating a new email (e.g., “New,” “Reply,”

“Reply All,” “Forward,” etc.), including information such as recipients (e.g., “To,” “Cc,” “Bcc,” etc.), subject, and body of the email;

TV: Tabular View (e.g., “List View”)—a tabular view used for viewing the content of an email folder (e.g., the “Inbox” folder), where each email is a row in a table;

FV: Full View—a view used when an email is opened from the List View, to display the email and associated information in detail (e.g., showing recipient information, subject, and body of the email, etc.);

LTN: Link to (create) new—create a new Action (e.g., from an email);

LTE: Link to existing—link one or email messages to a specific Project;

STB: Secondary Tool-bar; and

CCO: Create as a Child Of—create an Action as a child of a Project.

LTN and LTE are described in U.S. Patent Application Publication No. 2012/0096389, incorporated herein by reference.

The system includes EZ Macros (e.g., macros), which can be used when processing email. Each macro has a unique name and defines one or more associated elements (e.g., steps, components, configuration components, “recipe,” etc.) to be performed when the given macro is executed (e.g., a macro for inbound email could include LTN an Action+setup a Reminder+Archive given email). EZ Macros are displayed to the user using the secondary toolbar (STB) (described below) in conjunction with displaying a list of email messages in any email folders, when opening an email in Full View and when composing new, replying to, or forwarding email. EZ Macros are provided for every new user account created using the system (“out of the box” macros), which are copied for each new user from the database and specifically, from a set of given database tables called a “Master Workspace” configuration, which specifies all preconfigured non-email folders as well as all the out-of-the-box macros. Users can arrange (and/or re-arrange) the macros displayed on the “secondary toolbar,” as well as edit macros, create new macros, and remove macros.

The secondary tool-bar (STB) is displayed below the main (e.g., regular) toolbar of the email client application. The STB is shown when email is viewed in “Tabular View (TV)” (or “List View” (LV)), when email is viewed in “Full View” (FV), and when the user is composing new, replying to or forwarding email (collectively called “Create View” (CV)). While in TV the STB is visible whether the user has opened the “Inbox” folder as well as any other email folder. That is, macros can be executed to process email in the Inbox folder as well as in any other email folder.

The secondary toolbar shows existing macros and could include a “Macro Manager,” which could be depicted by a tooth wheel icon (e.g., gear). The position of macros on the secondary toolbar could be changed by the user (e.g., using a drag-and-drop operation). From the secondary toolbar, configuration components of each of the macros shown on the secondary toolbar can be changed “on-the-fly”. When changed on-the-fly, the user will have the option to “Apply changes to macro” or “Revert to original settings (of the given macro).” The secondary toolbar includes a “blank” selection (e.g., shown in the first position). A macro button (e.g., radio button) could be positioned next to (and/or include) each macro. If a radio macro button is used, only one macro can be selected at any given time. In this way, clicking on the radio button or macro name selects (and/or executes) the associated macro.

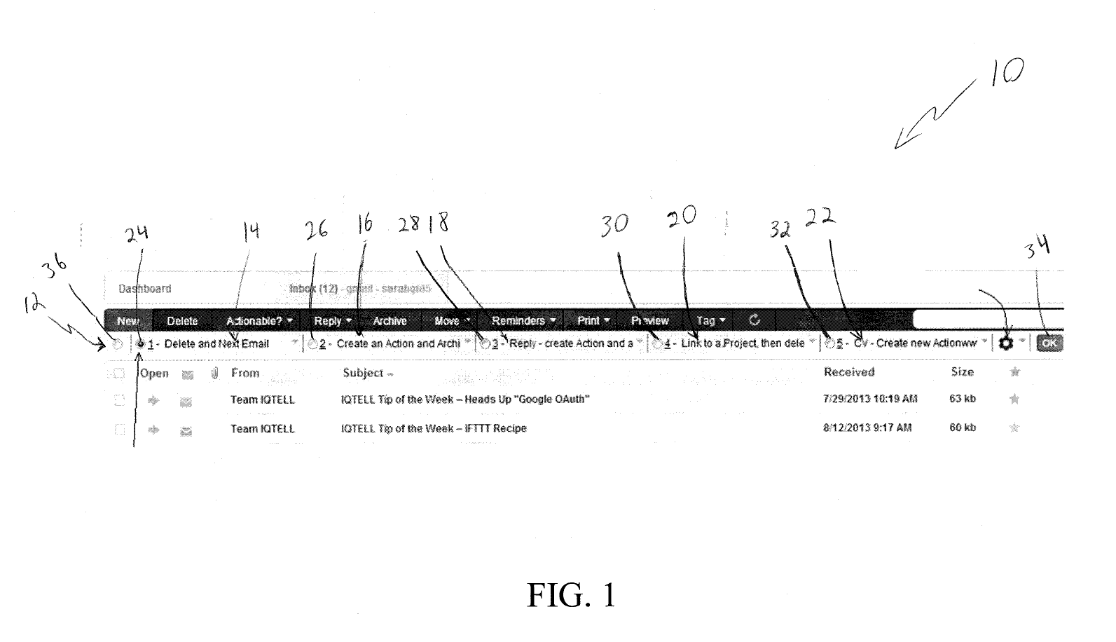

FIG. 1 is a screenshot 10 of a secondary toolbar (STB) 12 while in Tabular View, the secondary toolbar 12 including a plurality of macros 14, 16, 18, 20, 22 (e.g., user-defined macros). A user can re-arrange the position of any single macro on the secondary toolbar 12 (e.g., by drag-and-drop). Also, the user can hide (e.g., remove any macro from the secondary toolbar 12), and the user can use the Macro Manager to add any macros to the secondary toolbar. Each macro 14, 16, 18, 20, 22 includes a respective radio button 24, 26, 28, 30, 32. The “currently selected” macro 14 could be displayed as such via the “selected” radio button 24. Another way to show the “currently selected” macro 14 is by displaying the macro with a different background (e.g., changing the background to grey), which would not require radio buttons.

In TV, the “OK” button 34 is enabled if one or more emails are selected or if a “non-blank” macro is selected 36. In FV, the “OK” button is enabled if a “non-blank” macro is selected (not shown). The “OK” button could have different images for when the button is enabled and disabled. Macro execution could be triggered by clicking the “OK” button. Alternatively, macro execution could be triggered simply by clicking the desired macro button.

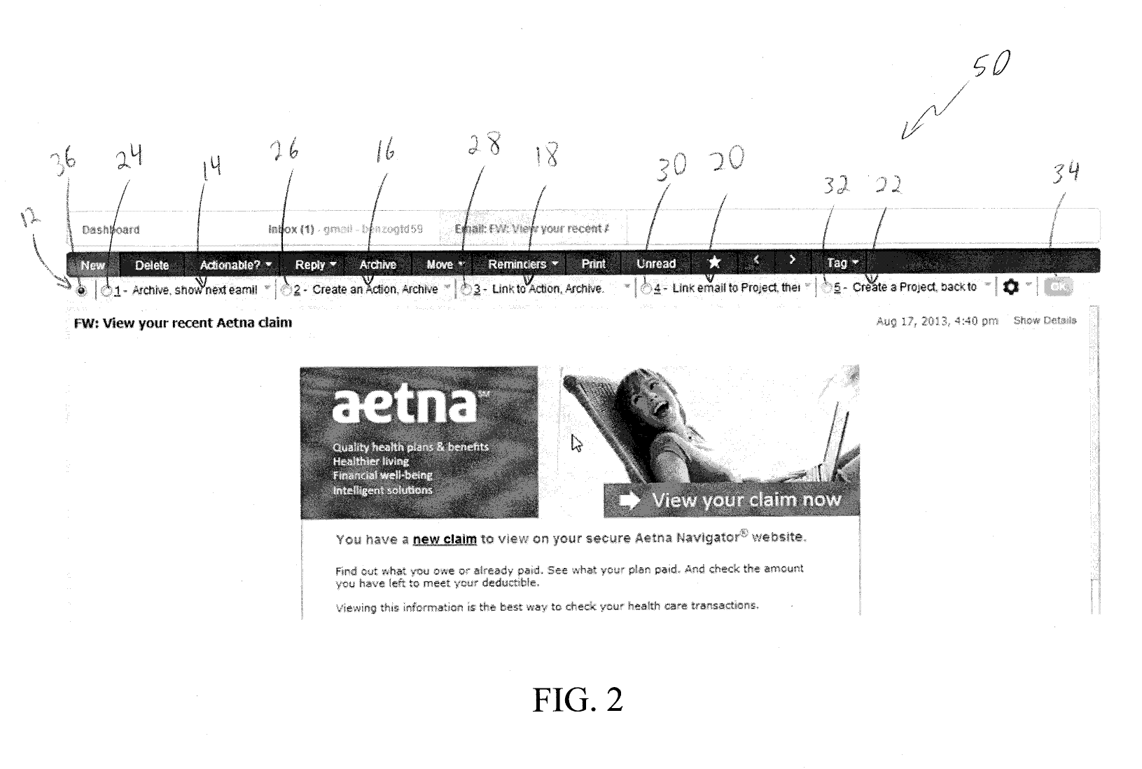

FIG. 2 is a screenshot 50 of the secondary toolbar 12 while in Full View, the secondary toolbar 12 including a plurality of macros 14, 16, 18, 20, 22 (e.g., user-defined macros). A user can arrange and/or re-arrange the macros 14, 16, 18, 20, 22 on the secondary toolbar in Full view (the same as in Tabular View). Macros 14, 16, 18, 20, 22 displayed in “Full View” could be specific to this view (e.g., they may be different than the macros used and/or shown on the secondary toolbar while in TV). For outbound email (e.g., CV, composed new emails (e.g., “Reply,” “Reply All,” or “Forward”), etc.)), macro execution could be triggered by clicking the “Send” button.

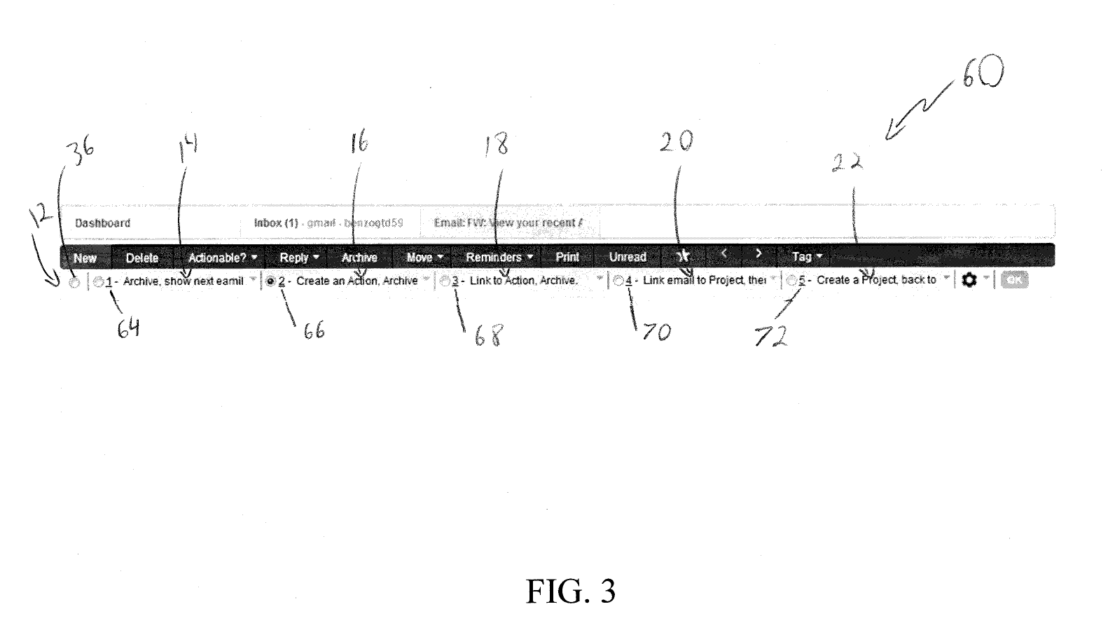

FIG. 3 is a screenshot 60 of the secondary toolbar 12 including keyboard shortcut prefixes (e.g., references). Automatically-designated keyboard shortcuts (e.g., implied keyboard shortcuts) allow for quick macro selection. More specifically, automatically-designated keyboard shortcuts allow users to select any macro 14, 16, 18, 20, 22 displayed on the secondary toolbar 12 without having to move a pointing device (e.g., a mouse) to click to select a desired macro 14, 16, 18, 20, 22, or to select no macro (e.g., the “blank” macro selection 36).

The system could automatically insert a prefix 64, 66, 68, 70, 72 (e.g., a numeral) corresponding to the position of each macro on the secondary toolbar (e.g., the left-most position designated as “1”, the second left-most position designated as “2”, etc.). The “blank” button 36 (e.g., the radio button for selecting no macro) is designated as “0,” and could not require a prefix. This allows a user to select a desired macro (or no macro) from any view (e.g., TV, FV, CV) using the keyboard. For example, when the user types “1” on the keyboard, the first macro will become selected (e.g., its radio button will be visually shown as depressed), when the user types “2” on the keyboard, the second macro will become selected. Further, when the user types “0,” any macro that may have been previously selected will be unselected, such that the radio button next to the “blank” macro 36 will then be shown as selected (e.g., no macro will be deemed selected).

The user can change the position of macros 14, 16, 18, 20, 22 displayed on the secondary toolbar 12 (e.g., using the drag and drop operation). When re-arranged, the prefixes 64, 66, 68, 70, 72 will be automatically adjusted (e.g., automatically re-numbered) by the system, so that each macro 14, 16, 18, 20, 22 will have its correct prefix 64, 66, 68, 70, 72 corresponding to the then current order of macros displayed on the secondary toolbar 12. The prefixes are also automatically adjusted when macros are being added or removed from the secondary toolbar 12 (discussed below).

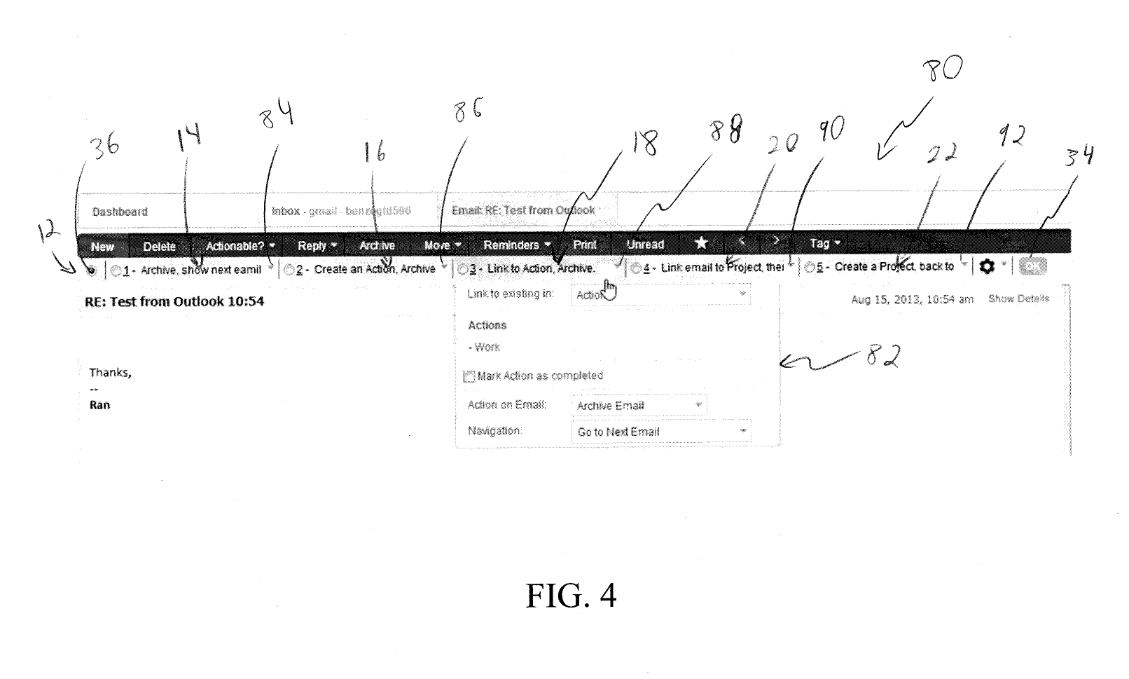

FIG. 4 is a screenshot 80 of a configuration menu 82 of a user-defined macro 18. When a macro is selected (other than the “blank” macro), typing the corresponding keyboard shortcut will open a configuration menu 82, which shows the configuration for that particular macro. This keyboard shortcut eliminates the need to use the mouse to point and click on the down-arrow 84, 86, 88, 90, 92 located next to each macro 14, 16, 18, 20, 22 to open (e.g., display) the configuration of the given macro.

A given keyboard shortcut is assigned to initiate macro execution. For example, the keyboard combination of ‘Ctrl+e’ could be assigned as a keyboard shortcut for “Execute the currently selected macro.” This eliminates the need to use to the mouse to point and click on the “OK” button 34. When using this keyboard shortcut, the system verifies that a given macro, other than the “blank” macro 36 is indeed selected, otherwise the user will be prompted accordingly (e.g., “Please select a Macro to execute”).

This screenshot 80 shows the current configuration of any macro 14, 16, 18, 20, 22 on the secondary toolbar. To activate this view, the user clicks on the down-arrow object 84, 86, 88, 90, 92 adjacently positioned to the right of each macro 14, 16, 18, 20, 22. When dropped-down, the user can view the current configuration of the macro (e.g., steps the macro will take when executed) from the configuration menu 82, which serves to remind the user of the specifics of any given macro 14, 16, 18, 20, 22. Additionally, this view of macros 14, 16, 18, 20, 22 allows the user to modify macro configuration before the macro 14, 16, 18, 20, 22 is executed (e.g., perform on-the-fly changes without requiring the user to go into edit mode).

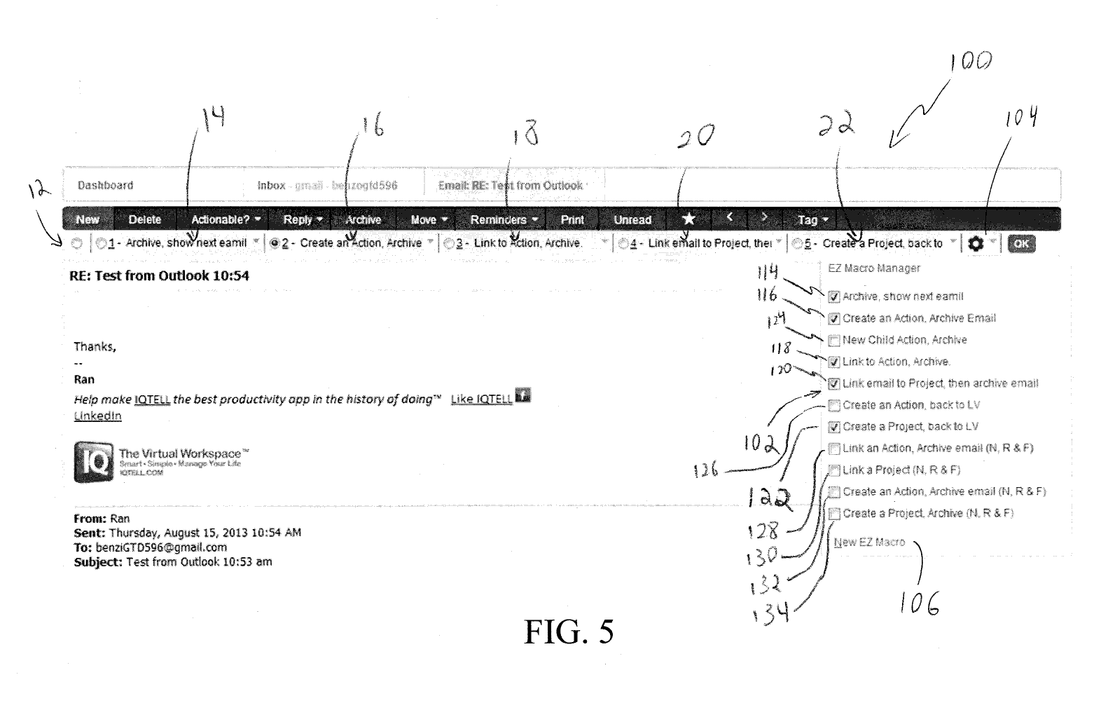

FIG. 5 is a screenshot 100 of a Macro Manager 102 (e.g., EZ Macro Manager) of the secondary toolbar 12. More specifically, the Macro Manager 102 could be accessed (e.g., dropped-open) from the gear icon 104 of the secondary toolbar 12, and is available in all views (e.g., List View, Full View, Create View, etc.).

The Macro Manager 102 allows a user to view (e.g., list), edit, and/or delete all existing (e.g., defined) macros 114, 116, 118, 120, 122, 124, 126, 128, 130, 132, 134, as well as create new macros. Further, the Macro Manager 102 allows a user to select which of the existing macros to show on the secondary toolbar 12 (e.g., where selected macros 114, 116, 118, 120, 122 correspond to macros 14, 16, 18, 20, 22 displayed on the secondary toolbar 12). When a macro is selected to be displayed on the secondary toolbar 12, the macro will be “appended” (e.g., shown as the last macro (right-most position)) on the secondary toolbar 12.

The Macro Manager 102 lists all currently defined macros, such that the user can easily select which macros to include in the secondary toolbar 12. The user could use the “New EZ Macro” link 106 (shown at the bottom of the drop-down) to create additional macros. When a macro is added, the macro is displayed on the secondary toolbar 12 (in the given view), and is automatically numbered (e.g., assigned the next highest number). Similarly, when a macro is removed from the secondary toolbar 12, the remaining macros are automatically renumbered accordingly (e.g., to correspond to their then current position on the secondary toolbar). A user can use the Macro Manager 104 to delete any macro. A deleted macro will be removed from the secondary toolbar 12 (e.g., from the current view as well as any other view said macro may have chosen to be displayed on the corresponding secondary toolbar).

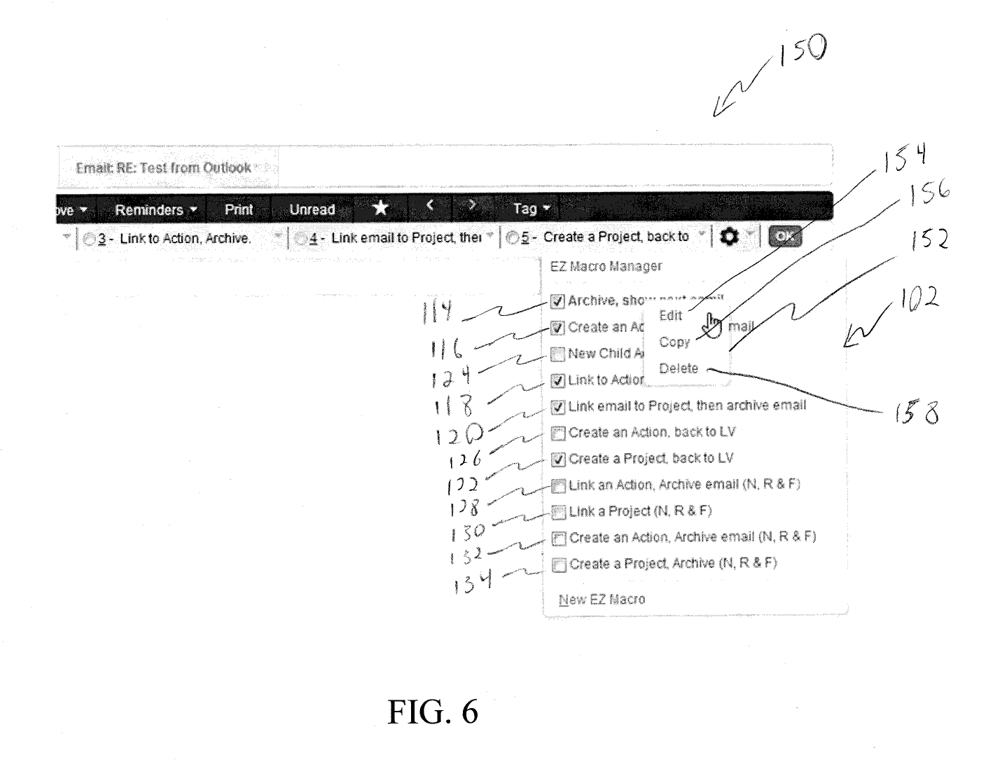

FIG. 6 is a screenshot 150 of a zoomed in view of the Macro Manager 102 showing a sub-menu 152 of a macro. A user can right-click over any given macro shown in the Macro Manager 102 to display a sub-menu 152 (e.g., right-click menu) that allows the user to edit, copy, or delete a specific macro. More specifically, clicking “Edit” 154 will open the Macro Editor, which displays the entire relevant macro configuration, allowing the user to change and save the configuration of the specific macro. “Copy” 156 allows the user to create an identical copy of the macro (e.g., clone an existing macro), where the user can use the existing configuration of the given macro as a basis to create a new macro with changed configuration (e.g., change the macro to fit the new desired functionality). “Delete” 158 allows the user to delete the given macro.

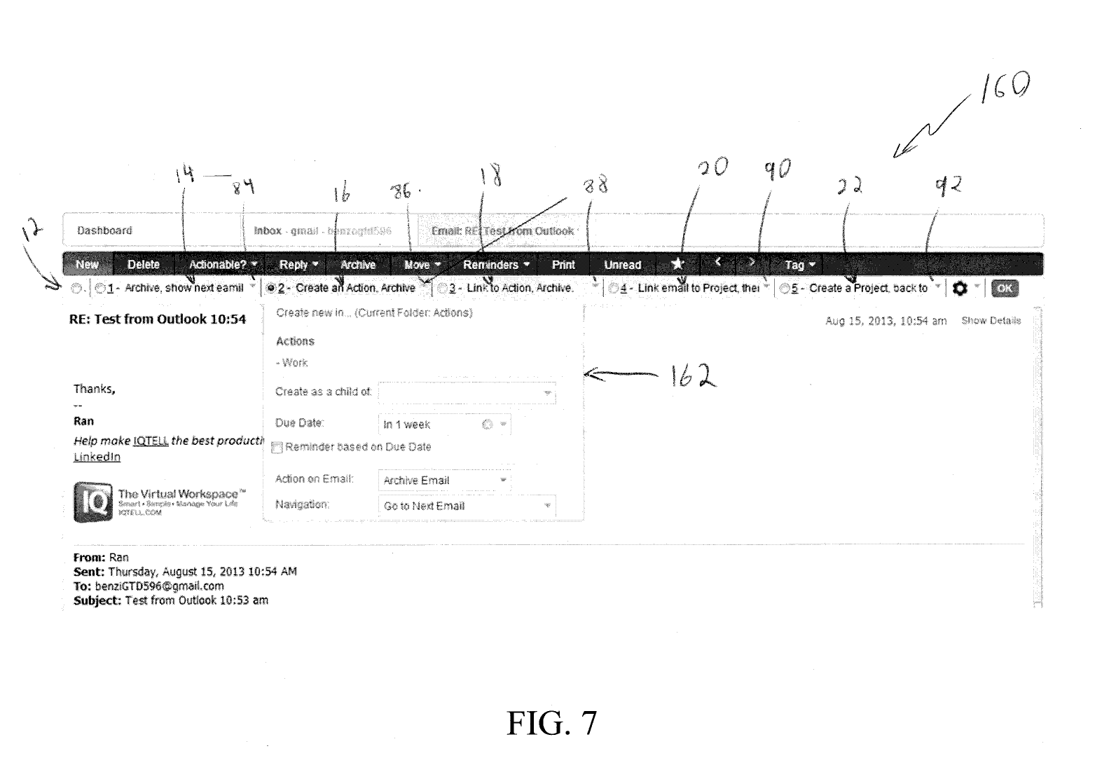

FIG. 7 is a screenshot 160 of a configuration menu 162 while in Create View (similar to FIG. 4). This allows a user to visualize and modify a macro configuration from the secondary toolbar 12. The configuration menu 162 for a particular macro can be accessed (e.g., dropped down) in a variety of ways, such as by clicking a down-arrow 84, 86, 88, 90, 92 for a particular macro 14, 16, 18, 20, 22 displayed in the secondary toolbar 12 (which could also select the associated radio-button for that particular macro), using a keyboard shortcut (e.g., if macro #3 is selected, then typing “3” on the keyboard will display the configuration of the macro), etc. The ability to view the current configuration of a macro, as well as applying on-the-fly configuration changes is available in all views (e.g., List View, Full View, Create View, etc.). To close the configuration menu 162, a user could click again on the same macro within the secondary toolbar 12, type the same keyboard shortcut again (e.g., clicking on “3” on the keyboard), click on the ‘<Esc>’ key, and/or click on another macro.

When the configuration menu 162 is displayed, the user can view the given macro configuration and execute the macro (e.g., without alteration), or the user can apply configuration changes (e.g., change the “instructions” of what the given macro will perform when executed). When any changes (e.g., on-the-fly changes) are made to the macro, the user can revert to the original setting of the macro, apply the given changes to replace the original settings of this macro, or execute the macro based on these changes (without affecting the original settings of this macro). On-the-fly changes applied to a macro will stay in effect for the duration of the session. When the user signs out and then sign back into the system, the original macro settings will be restored. Examples of on-the-fly changes include changing the folder in which an action will be created (e.g., “Actions,” “Projects,” etc.), as well as changing the Due Date, Follow-up Date, and/or the Context of the Action to be created.

Other examples of on-the-fly changes include the following examples. If LTN or LTE is specified, the macro configuration men 162 shows the folder where the given LTN or LTE should be performed, and the user can change the destination (e.g., choose another folder or sub-folder). If LTE is specified when executing the given macro, the user indicates whether the Action being linked to/from the given email should be marked as “Completed.” If LTN is specified, the user is allowed to change the predefined Due Date and/or the Context of the new Action created from executing the given macro. If Move is specified, the user is allowed to change the destination of where the given email should be moved. If Archive is specified, the user is allowed to change whether the given email should be archived or not. When executing a macro in FV, the user is allowed to change whether to go to next email, previous email, or return to TV.

The Macro Pool stores all macros in one pool that is common to all views. Using the Macro Manager in any view (e.g., TV, FV, CV, etc.), the user can pick-and-choose which macros from the pool should be displayed on the secondary toolbar when in a given view. For example, the macro “Link and Archive” may be displayed on the secondary toolbar while in TV or FV but not displayed when in CV.

Further, the Macro Manager can create new macros. When a new macro is created by the user, the macro is automatically added to the secondary toolbar of the current view. This provides the convenience for the user to create or modify any macro whenever the Macro Manager is open from the given view (e.g., FV regardless of the particular email account or the specific email that is currently being viewed). For example, if the macro “Link and Archive” was created while in FV, the macro will be added and shown on the secondary toolbar of FV. As a result, this new macro will be displayed on the secondary toolbar whenever any email folder is opened in the user's workspace for any of the user's email accounts within the given workspace, and whenever an email is in view in FV.

A pool of one or more macros could be made available “out of the box” (e.g., automatically available to existing users and new users.” This way, users can start using the system without having to create their own macros from scratch. Once users grow accustomed to using macros, the users can create their own macros, as well as hide and show macros in various views.

Using the concept of a “Master Workspace,” an “Admin User” can configure macros for the different views, designated as “System Macros.” When releasing the new functionality, the system automatically copies (e.g., instantiates) the System Macros to existing users. For new users (e.g., users who create a new account using this system), the system will copy the System Macros to be incorporated in their workspace as well.

The following are sample macro components (e.g., while in CV (outbound)). “LTN” automatically creates a new Action (e.g., a new entry in a non-email “Actions” folder) when creating a new email, and links the newly created Action with the sent email. This way, when viewing either the Action or the Email, the link is visible, which keeps the user informed of both the email (e.g., what has created the Action) and the Action (e.g., the need to complete the Action).

“LTN and set Due Date and/or Context” is a variation of the “plain” LTN, which allows users to specify the value of certain fields for an Action to be created (e.g., “Due Date—in 7 days from date of creation”, “Context=‘work’”, etc.). In this way, for the newly created Entry (e.g., only for Workflow-enabled items), Context can be added if this field is used by the destination folder or sub-folder, and/or Due Date (e.g., “Follow-up Date”) can be added if the Entry to be created is a reminder.

“Create as a child of (CCO)” is a variation of LTN. In this case, the newly created non-email entry (e.g., an action) is specified to be created as a “child” of another non-email entry (e.g., a project). Using this example, the intent is to create the new non-email entry not as a standalone (independent) action but rather, as an action that is a “child” of an existing project, that is, maintaining a project as a parent (placeholder) of multiple actions. In this way, when viewing a project, the user can see all open actions (e.g., what needs to be done to complete the given project). Therefore, configuring a macro that includes the CCO components requires (i) definition of the non-email folder where the new entry will be created (e.g., “Actions”); and (ii) the definition of the non-email folder from where the user will select an existing entry (e.g., the given project) to become the “parent” of the newly created entry. These two definitions now become predetermined elements in such a given macro. Using the “action as a child of a project” use-case, when such a macro is executed to process a given email, the following principal steps will take place (i) a new action will be created based on the given email; and (ii) the user will be prompted to select the specific project to be used as the “parent” of the new action.

“LTE” links the sent email (e.g., when replying to an email) to an existing Project or Action. This way, when a user opens an Action or Project, the user can see all email that was sent relative to the given Action or Project. “LTE and Mark as complete” is a variation of the “plain” LTE operation, where the linked-to entry (e.g., Action or Project) is marked as complete (e.g., workflow-enabled only). LTN and LTE could have mutual exclusivity while in CV.

“Calendar event” adds the newly created email as an event on the Calendar. “Reminder” sets a reminder for the newly created email. “Archive” archives the email that the user is replying to or forwarding an existing email (e.g., moved from the “Inbox” to the “Archive” folder). This operation could not be available when creating (e.g., composing) and sending a new email. “Move” moves the email that the user is replying to or forwarding to a pre-defined folder or sub-folder. This operation could not be available when creating (e.g., composing) and sending a new email (e.g., similar to “Archive”).

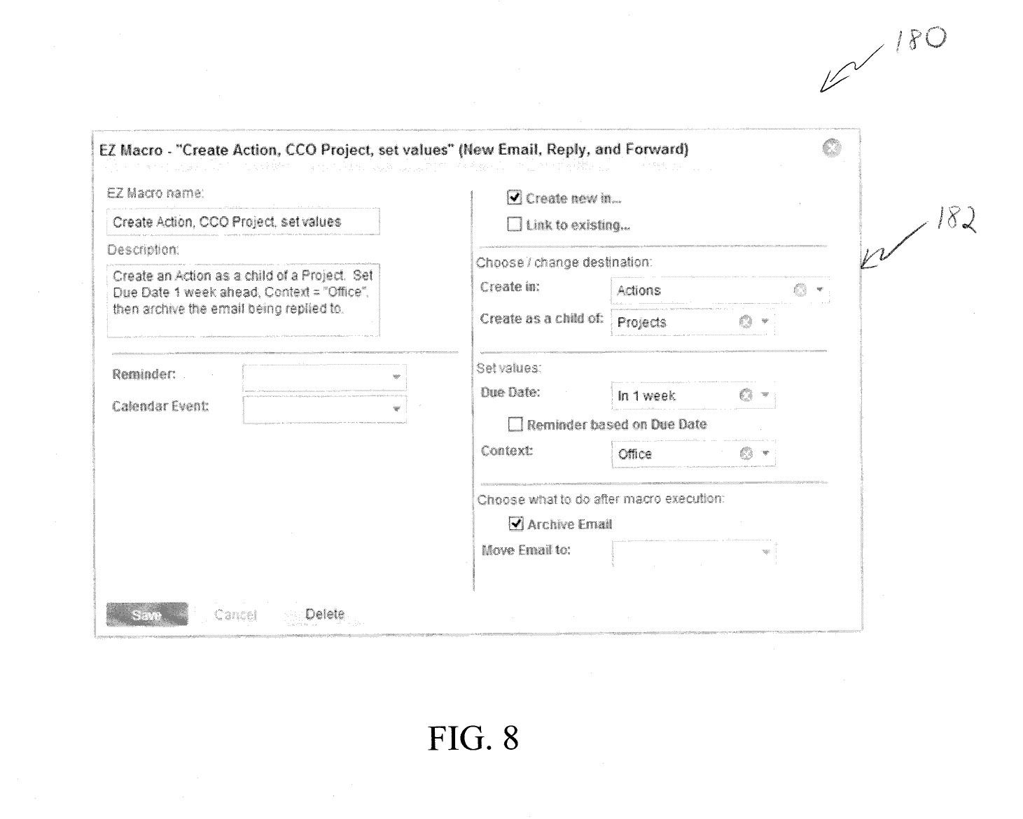

FIG. 8 is a screenshot 180 of a Macro Editor 182 while in Create View (CV). More specifically, the screenshot 180 shows the configuration of any given macro while in Create View (CV), but is available in all views (e.g., List View, Full View, Create View). The Macro Editor 182 allows users to view and modify all aspects of a macro (e.g., similar but more expansive than on-the-fly).

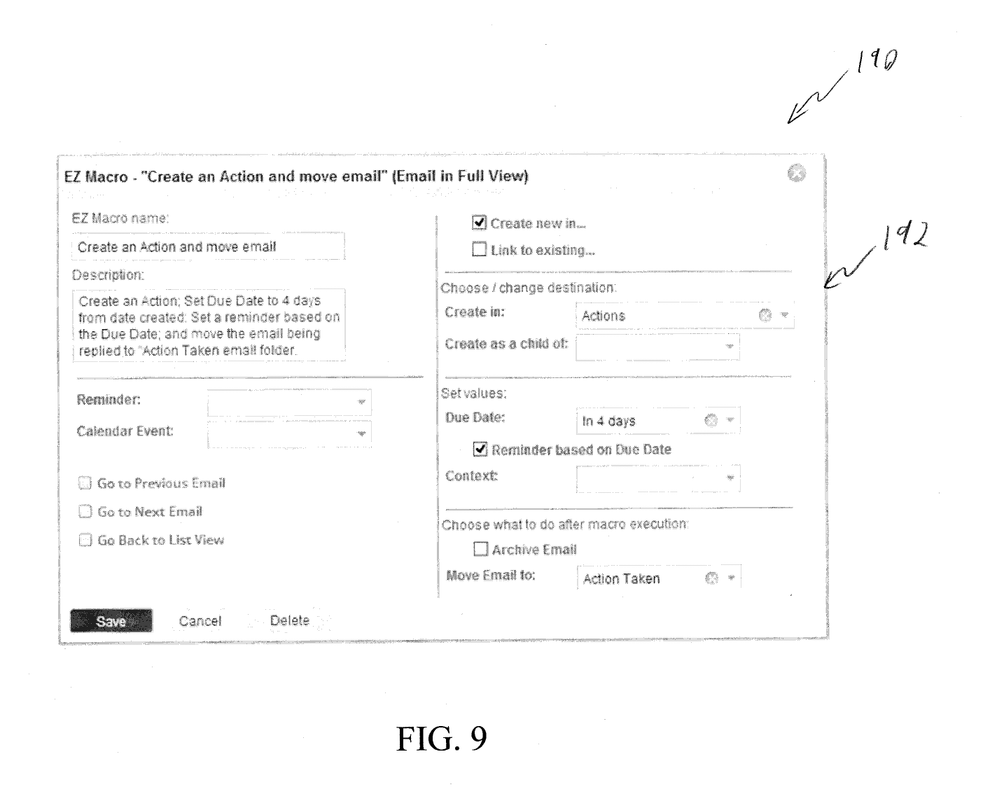

FIG. 9 is a screenshot 190 of a Macro Editor 192 while in Full View. This screenshot 190 shows the configuration of any given macro while in Full View (FV). Macro components available while in FV (Inbound) include “LTN,” “Set Due Date,” “Set Context,” “Create as a child of (CCO),” “LTE,” “LTE and “Mark as complete,” “Calendar event,” “Reminder,” and actions on email “Delete,” “Archive,” “Move.” Also, in Full View, the user can also configure what to view once the given macro is executed (e.g., “Go to Previous Email”, “Go to Next Email”, or “Go Back to List View”).

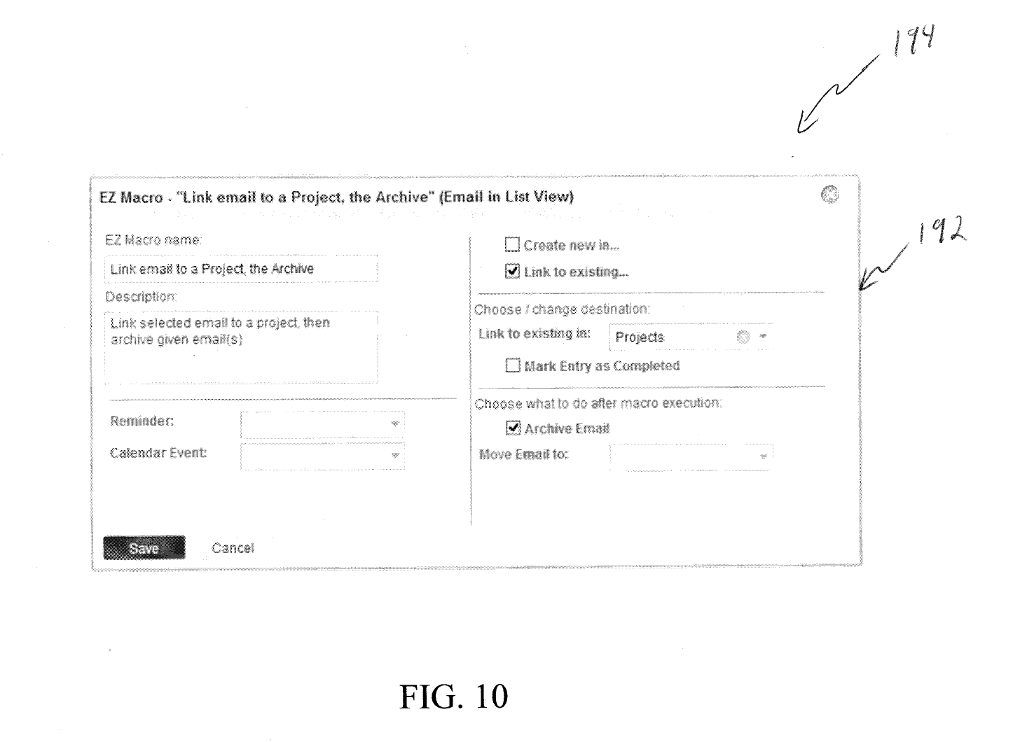

FIG. 10 is a screenshot 194 of a Macro Editor 192 while in List View (e.g., “Tabular View” TV). The configuration abilities while in this view are identical to those available for macros in Full View with the exception of “Go to Previous Email,” “Go to Next Email,” or “Go Back to List View” (as they are not applicable in TV).

When a macro is created/edited, a destination folder ‘x’ (e.g., to move the email to) can be specified. More specifically, when a macro is created/edited with a “Move email to” operation, it is while in TV or FV and while in a given email account ‘A’. When the given macro is viewed in the secondary toolbar while in a different (e.g., second) email account ‘B’, the given folder ‘x’ may or may not exist for that email account ‘B’. There could be a one-to-many table (e.g., designated “Macro_move_email”) having columns of {macro_id, email_account_id, move_folder_id, move_folder_name, date_created}. Any given macro, uniquely identified to the user by the macro name and having a “Move email to” operation will have at least one entry in the “Macro_move_email” table.

When the given macro is shown in the secondary toolbar (e.g., when a given macro includes a “Move email to” operation) or edited off the EZ Macro Manager and the given macro_id has no row in the “Macro_move_email” table corresponding to the given “macro_id” and the current “email_account_id” then: (1) for the given “macro_id” SELECT move_folder_name FROM Macro_move_email WHERE macro_id=<given macro_id> SORT BY date_created ASC, and select the first returned value (e.g., hence the first-defined “move_folder_name”), (2) within the current email account “Inbox” folder structure attempt to find a folder that matches (e.g., case insensitive) the “move_folder_name” that was fetched (as per above), and if found, create a new row in the “Macro_move_email” table with the appropriate values of the given “macro_id”, “email_account_id”, “move_folder_id”, and “move_folder_name”, and the then current “date_created”, (3) if within the given email account “Inbox” folder structure no matching folder is found, then when the given macro is shown in the Macro Editor, the “Move email to” object will be blank, in which case, the user can explicitly search/set the desired destination folder for the “Macro_move_email”, in which case, a new row should be created in the “Macro_move_email” table with the appropriate values of the given “macro_id”, “email_account_id”, “move_folder_id”, and “move_folder_name”, and the then current “date_created”, and (4) when a Macro is executed a “Move email to” will take place only when there is a corresponding row in the “Macro_move_email” table matching the given “macro_id” and the given then current “email_account_id”.

EZ Macro Execution while in CV (outbound mode) could include several aspects. When composing a New email (e.g., Reply, Reply All, Forward, etc.), the “blank” radio button will be selected by default. At any point, before clicking on the “Send” button, the user can select any desired Macro, or even create and select a new macro on-the-fly. When pressing the “Send” button: (1) the email gets sent out, (2) the selected Macro (if not “blank”) gets executed using the email just sent as a reference (e.g., if the Macro contained “Create an Action,” the newly created Action will show (e.g., reference) the email just sent as its “parent” (e.g., it will show it as the “Originating email”), (3) if LTE was specified, then the “floating TV” pop-up will be given to allow the user to select the specific Entry to be LTE, and (4) if “Create as a Child Of (CCO)” was specified the “floating TV” will be displayed, so that the user can choose the destination parent entry (e.g., the given parent Project).

EZ Macro Execution while in email FV (inbound mode) could include several aspects. If the “Blank Macro” is selected, the “OK” button will be disabled. The user can select a given Macro, in which case, the “OK” button becomes enabled. The user can then click the “OK” button and the given Macro will get executed. Depending on the selected macro (and its defined steps) email FV can stay, showing the same email, or the next email (if any), and/or email FV may be closed, returning to Email in TV. If LTE was specified, then the “floating TV” pop-up will be shown to allow the user to select the specific Entry to be LTE. If “Create as a Child Of (CCO)” was specified the “floating TV” will be displayed, so that the user can choose the destination parent entry (e.g., the given parent Project).

EZ Macro Execution while in email TV (inbound mode) could include several different aspects. If the “Blank Macro” is selected, the “OK” button will be disabled. If one or emails in TV are selected, then the user can select a given Macro, in which case, the “OK” button becomes enabled. When the “OK” button is enabled, it can be clicked, which will execute the given macro individually for each of the selected email message(s). If LTE was specified, then the “floating TV” pop-up will be given to allow the user to select the specific Entry to be LTE. If “Create as a Child Of (CCO)” was specified the “floating TV” will be displayed, so that the user can choose the destination parent entry (e.g., the given parent Project). If more than one email is selected and the executed macro contains LTN component, then no tab will be opened for these LTN's (e.g., these new Entries will be created and will require no user interaction in doing so).

The following are steps associated with EZ Macros: (1) creating a macro, (2) placing the macro to be visible and accessible, (3) executing a macro, and (4) editing a macro.

Users can create new macros. A macro can be created using the EZ Macro Manager (“Macro Manager”), from where the user can click on “New EZ Macro”, which will invoke the Macro Editor. The Macro Editor can also be used to modify an existing macro. Once the user specified/selected the desired configuration for a macro, using the Macro Editor, the user can click on “Save” to save the new macro or the one that was modified.

Users can place the macros to be visible and accessible. Using the Macro Manager, any macro listed in the macro pool (as shown on the Macro Manager drop-down) can be chosen by the user to be displayed on the secondary toolbar of the then current view (e.g., TV, FV, CV, etc.). Using the Macro Manager, the user may also decide to “un-check” a macro, so that it is no longer displayed on the secondary toolbar of the then current view. Any macro displayed on the secondary toolbar can be hidden (e.g., via right-click on the given macro and choosing the “Hide” menu option). Using the secondary toolbar provided, and drag-and-drop functionality, the position of any macro on the secondary toolbar can be changed.

Users can execute one or more macros. First, a macro displayed on the secondary toolbar needs to be selected (e.g., clicking on its associated radio-button, using its associated implied keyboard shortcut, etc.). Once a macro is selected and while in TV or FV, the selected macro will be executed by clicking on the “OK” button or by using the ‘Ctrl+e’ keyboard shortcut. Once a macro is selected and while in CV, the selected macro will be executed after the email was sent, hence, the user has to first click on the “Send” button, and then once the email was sent, the system will automatically “follow through” and execute said macro.

Users can edit a macro. At any time, either before or after macro execution, existing macros can be edited (e.g., the user ay view current configuration and apply changes). Opening an existing macro for edit can be done by right-clicking on the macro while it is viewed in the secondary toolbar and from there choosing the “Edit” option. Opening an existing macro for edit can also be done by opening the Macro Manager, which shows a list of all the existing macros, from where the user can right-click on any given macro and select “Hide” from the menu that appears. When the user chooses “Edit” the system automatically opens the EZ Macro Editor (“Macro Editor”). Using the Macro Editor, the user can rename the macro, update its description and change or add any of it configuration. Using the Macro Manager, when all changes are done, the user clicks on the “Save” button there to save all the changes. Alternatively, the user can also cancel all the changes and revert to the original macro.

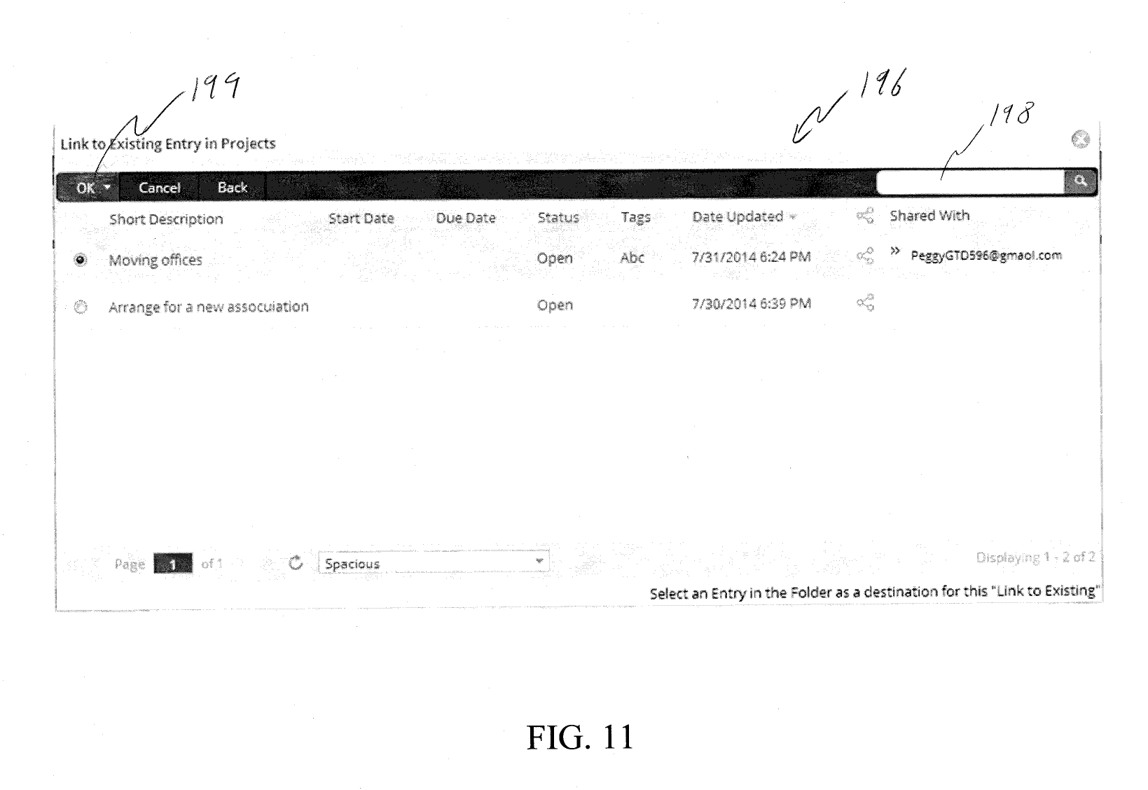

FIG. 11 is a screenshot 196 of a destination entry selection. The screenshot 196 shows how the user can select a specific non-email entry when a macro is executed, such as when the macro has an LTE or a CCO component. Shown is a pop-up having a Tabular View (TV) of a non-email folder, which shows all entries in that folder. The user can scroll and page through the entries or use the search object 198 to search for a specific entry in the folder. When the user selects a given entry, the user can then click the “OK” button 199, thereby executing either the LTE or CCO operation, as configured by the given macro.

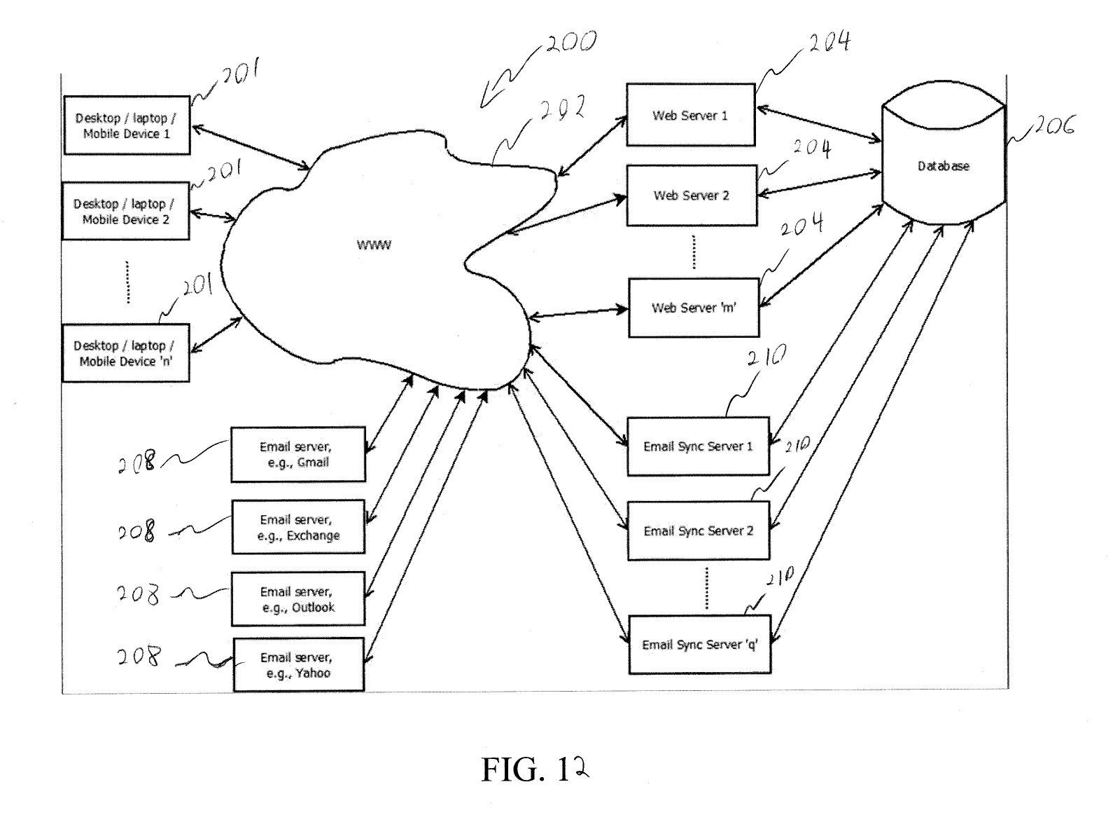

FIG. 12 is a system diagram 200. More specifically, the diagram shows IQTell system 200 main components, such as user input/display devices 201 (e.g., a desktop, laptop, mobile device, etc.). Data flows using the Internet through the world wide web 202 (e.g., using Secure Sockets Layers (SSL)). The system 200 uses a plurality of web servers 204 that balance the load of data so that the entire system is capable of scaling to support a growing user base. A database 206 stores all the user data, email data, as well as all other users' workspace data (e.g., Actions, Projects, Contacts, etc.). The database 206 uses a plurality of machines to support a growing number of users and their data. Email servers 208 of existing 3rd-party email providers (e.g., Gmail, Exchange, Outlook, Yahoo, iCloud, etc.) allows user-related email data to flow through the cloud in both directions. IQTell Email Sync servers 210 that sync user email data to and from the corresponding Email servers 208 and the IQTell database 206. Using the Web Servers 204, email data as well as non-email data (e.g., data related to Actions, Projects, Contacts, etc.) is sent to the users' devices 201 for display to a user. Consequently, new email as well as new non-email data created or modified by the users using their devices 201 is sent back through the cloud to be stored in the database 206.

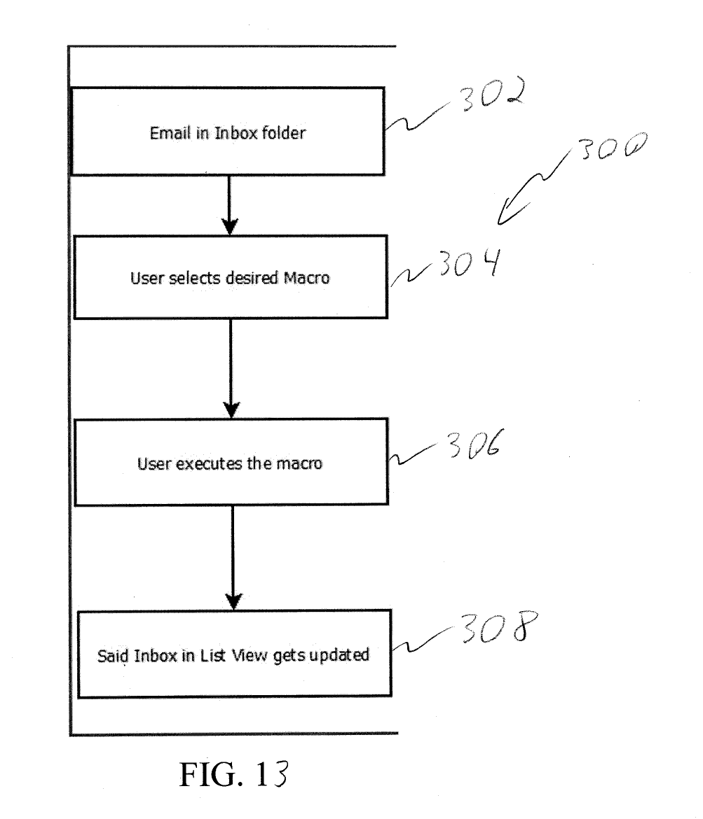

FIG. 13 is a flowchart showing processing steps 300 carried out by the system. In step 302, a user opens an email folder in List View. In step 304, the user selects one or more macros. In step 306, the user clicks to execute the selected macro. In step 308, the List View gets updated if the macro executed included a Delete, Archive or Move operation.

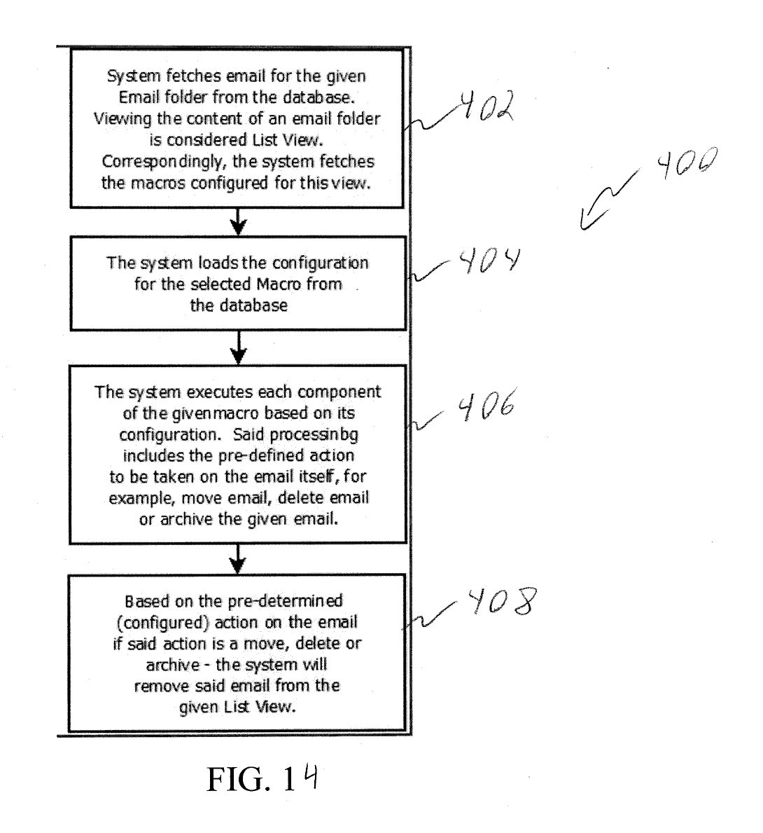

FIG. 14 is a flowchart showing processing steps 400 carried out by the system to facilitate the expected results. In step 402, the system fetches the email for the given user from the given email folder (e.g., the “Inbox” folder). While displaying the email in List View, the system also fetches the macros that have been configured by the user to be displayed in this view. The user can configure different macros to be displayed in each of the views (e.g., List View, Full View, Create View, etc.). In step 404, when the user selects a given macro the system fetches the corresponding macro configuration so that the user can view the configuration (e.g., to modify elements of the macro). In step 406, when said Macro is executed, the system performs all operations of the macro as per the configuration thereof (e.g., create a new Action, copy the subject of the Email to the Short Description of the Action, copy the HTML body of the Email to the Detail memo field of the Action, and archive the email) In step 408, the system checks whether the List View needs to be updated, which could be required if the macro included a Move, Archive or Delete operation.

The following table includes computer codes that comprise the database (e.g., table) structure for the system and method described above:

TABLE 1

| CREATE TABLE macro | |
|---|---|
| ( | |
| id | serial primary key, |
| ws_id | int, |
| name | text, |
| description | text, |
| seq_no | int, |
| view_type_value | varchar(20), -- |
| | CREATE_VIEW, FULL_VIEW, |
| TABULAR_VIEW | |
| visible | smallint, |
| system | smallint, |
| post_execution_value | varchar(20), -- |
| | DELETE, ARCHIVE, MOVE |
| return_navigation_value | varchar(20), -- |
| | NONE, NEXT_MESSAGE, |
| | TABULAR_VIEW |
| created_by_user_id | int, |
| date_created | timestamp, |
| date_updated | timestamp |
| ); | |
| CREATE TABLE macro_link_to_new_operation | |
| ( | |
| id | serial primary key, |
| macro_id | int, |
| folder_id | int, |
| create_as_child_of_folder_id | int, |
| created_by_user_id | int, |
| date_created | timestamp, |
| ate_updated | timestamp |
| ); | |
| CREATE TABLE macro_link_to_existing_operation | |
| ( | |
| id | serial primary key, |
| macro_id | int, |
| folder_id | int, |
| mark_as_completed | smallint, |
| created_by_user_id | int, |
| date_created | timestamp, |
| date_updated | timestamp |
| ); | |
| CREATE TABLE macro_set_selection_field_option | |
| ( | |
| id | serial primary key, |
| ltn_operation_id | int, |
| df_id | int, |
| selection_value_id | int, |
| created_by_user_id | int, |
| date_created | timestamp, |
| date_updated | timestamp |
| ); | |
| CREATE TABLE macro_set_date_field_option | |
| ( | |
| id | serial primary key, |
| ltn_operation_id | int, |
| df_id | int, |
| number | int, |
| unit | varchar(20), |
| reminder | smallint, |
| created_by_user_id | int, |
| date_created | timestamp, |
| date_updated | timestamp |
| ); | |
| CREATE TABLE macro_add_calendar_event_operation | |
| ( | |
| id | serial primary key, |
| macro_id | int, |
| calendar_id | int, |
| number | int, |
| unit | varchar(20), |
| created_by_user_id | int, |
| date_created | timestamp, |
| date_updated | timestamp |
| ); | |
| CREATE TABLE macro_set_reminder_operation | |
| ( | |
| id | serial primary key, |
| macro_id | int, |
| number | int, |
| unit | varchar(20), |
| created_by_user_id | int, |
| date_created | timestamp, |
| date_updated | timestamp |
| ); | |
| CREATE TABLE macro_post_execution_move_mail | |
| ( | |
| id | serial primary key, |
| macro_id | int, |
| mail_box_id | int, |
| folder_path | text, |
| created_by_user_id | int, |
| date_created | timestamp, |
| date_updated | timestamp |
| ); | |

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A system for processing electronic mail, comprising:
a computer system in electronic communication with a network, the computer system receiving and sending one or more email messages over the network; and
an email client application executed by the computer system, the email client application generating on said computer system:
an electronic user interface for allowing a user to process the one or more email messages;
a first toolbar for allowing the user to control operation of the email client application; and
a secondary toolbar including at least one macro button selectable by the user when the one or more email messages are displayed to the user in the electronic user interface, the at least one macro button having assigned thereto a user-definable macro which, when selected by the user, automatically processes the one or more email messages.

2. The system of claim 1, wherein the user-definable macros creates an action associated with an email message.

3. The system of claim 1, wherein the user-definable macros link selected email messages, including metadata, to a project stored in a database in electronic communication with the computer system.

4. The system of claim 1, wherein the one or more email messages are new emails created at the computer system.

5. The system of claim 1, wherein the one or more email messages are emails received at the computer system.

6. The system of claim 1, wherein the at least one macro button is a radio button.

7. The system of claim 1, wherein at least one of the macro buttons is accessible by a keyboard shortcut.

8. A method for processing electronic mail, comprising:
receiving or sending, by a computer system in electronic communication with a network, one or more email messages over the network;
executing, by a computer system, an email client application;
generating, by the email client application, an electronic user interface for allowing a user to process the one or more email messages;
generating, by the email client application, a main toolbar for allowing the user to control operation of the email client;
generating, by the email client application, a secondary toolbar including at least one macro button;
selecting, by the user, the at least one macro button when the one or more email messages are displayed to the user in the electronic user interface, the at least one macro button having assigned thereto a user-definable macro; and
automatically processing, by the computer system, the one or more email messages according to the user-definable macro.

9. The method of claim 8, further comprising creating, by the user-definable macro executed by the computer system, an action associated with an email message.

10. The method of claim 8, further comprising linking, by the user-definable macro executed by the computer system, selected email messages, including metadata, to a project stored in a database in electronic communication with the computer system.

11. The method of claim 8, wherein the one or more email messages are new emails created at the computer system.

12. The method of claim 8, wherein the one or more email messages are emails received at the computer system.

13. The method of claim 8, wherein the at least one macro button is a radio button.

14. The method of claim 8, wherein at least one of the macro buttons is accessible by a keyboard shortcut.

15. A non-transitory computer-readable medium having computer-readable instructions stored thereon which, when executed by a computer system, cause the computer system to perform the steps of:
receiving or sending, by the computer system in electronic communication with a network, one or more email messages over the network;
executing, by a computer system, an email client application;
generating, by the email client application, an electronic user interface for allowing a user to process the one or more email messages;
generating, by the email client application, a main toolbar for allowing the user to control operation of the email client;
generating, by the email client application, a secondary toolbar including at least one macro button;
selecting, by the user, the at least one macro button when the one or more email messages are displayed to the user in the electronic user interface, the at least one macro button having assigned thereto a user-definable macro; and
automatically processing, by the computer system, the one or more email messages according to the user-definable macro.

16. The computer-readable medium of claim 15, further comprising creating, by the user-definable macro executed by the computer system, an action associated with an email message.

17. The computer-readable medium of claim 15, further comprising linking, by the user-definable macro executed by the computer system, selected email messages, including metadata, to a project stored in a database in electronic communication with the computer system.

18. The computer-readable medium of claim 15, wherein the one or more email messages are new emails created at the computer system.

19. The computer-readable medium of claim 15, wherein the one or more email messages are emails received at the computer system.

20. The computer-readable medium of claim 15, wherein the at least one macro button is a radio button.

21. The computer-readable medium of claim 15, wherein at least one of the macro buttons is accessible by a keyboard shortcut.
